(19) United States
(12) Patent Application Publication
(10) Pub. No.: US 2022/0042538 A1
(43) Pub. Date: Feb. 10, 2022

(54) Fastener Device

(71) Applicant: Robert Rosebrugh, Oxnard, CA (US)

(72) Inventor: Robert Rosebrugh, Oxnard, CA (US)

(21) Appl. No.: 17/395,396

(22) Filed: Aug. 5, 2021

Related U.S. Application Data
(60) Provisional application No. 63/061,557, filed on Aug. 5, 2020.

(51) Int. Cl. F16B 35/04; F16B 13/02; F16B 13/04

(52) U.S. Cl. CPC F16B 35/041; F16B 13/045; F16B 13/02

(57) ABSTRACT

A fastener device, adapted to be installed on a wall through an aperture of the wall, has an inner stud that is sized to fit through the aperture of the wall, and an outer stud that engages the inner stud. The inner stud has a securing mechanism on an outer surface of the inner stud. A spiral structure has an inner diameter that is sized to receive the inner stud, wherein the inner diameter engages with the securing mechanism of the inner stud. The outer fastener engages the inner stud to compress the spiral structure into a washer-like structure.

### CROSS-REFERENCE TO RELATED APPLICATIONS

This application for a utility patent claims the benefit of U.S. Provisional Application No. 63/061,557 filed Aug. 5, 2020.

### BACKGROUND OF THE INVENTION

### Field of the Invention

This invention relates generally to fasteners, and more particularly to blind fasteners.

### Description of Related Art

The prior art teaches a variety of blind fasteners for mounting objects to a wall through an aperture when the space behind the wall cannot be readily accessed.

For example, the prior art teaches a wide variety of toggle bolts which include a cross-piece that can pivot to a lateral position such that the cross-piece extends across the opening through the wall, to prevent the bolt from being pulled back through the wall.

The prior art devices suffer serious disadvantages. Many prior art fasteners are difficult to install, and provide a weak mount that can be unreliable. Toggle bolts can be difficult to operate, and provide relatively weak and unreliable fastening ability. For example, when a lateral force is applied to a toggle bolt, from a direction traverse the cross-piece, the cross-piece provides very little stability to the bolt. There is a long-felt need in the art for a fastener device that is strong, reliable, easy to install, and which provides 360 degree support to the bolt of the fastener device.

### SUMMARY OF THE INVENTION

The present invention teaches certain benefits in construction and use which give rise to the objectives described below.

The present invention provides a fastener device adapted to be installed on a wall through an aperture of the wall. The fastener device includes an inner stud that is sized to fit through the aperture of the wall, the inner stud having a securing mechanism on an outer surface of the inner stud; a spiral structure having an inner diameter that is sized to receive the inner stud, wherein the inner diameter engages with the securing mechanism of the inner stud; and an outer fastener that engages the inner stud to compress the spiral structure into a washer-like structure.

A primary objective of the present invention is to provide a fastener device having advantages not taught by the prior art.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is an exploded side elevational view of a fastener device according to a first embodiment of the present invention;

FIG. 2 is a side sectional view thereof, illustrating an installation tool used in conjunction with the fastener;

FIG. 3 is a perspective view of the fastener device according to a second embodiment of the present invention, shown in an assembled configuration;

FIG. 4 is a sectional view thereof taken along line 4-4 in FIG. 3;

FIG. 5 is a sectional view thereof, showing the fastener device installed in a wall;

FIG. 6 is a sectional view of a third embodiment of the fastener device; and

FIG. 7 is a sectional view of a fourth embodiment of the fastener device.

### DETAILED DESCRIPTION OF THE INVENTION

The above-described drawing figures illustrate the invention, a fastener device that is adapted to be installed on a wall through an aperture in the wall. This is particularly useful in situations where the back side of the wall cannot readily be accessed, and the installation must be made entirely through the aperture of the wall. For purposes of this application, the term “wall” is defined to include any surface to which an attachment is desired, such as a wall in a structure (i.e., to drywall of the structure), a vehicle having a wall that forms a body of the vehicle (e.g., truck, automobile, boat, aircraft, etc.), or any other similar structure.

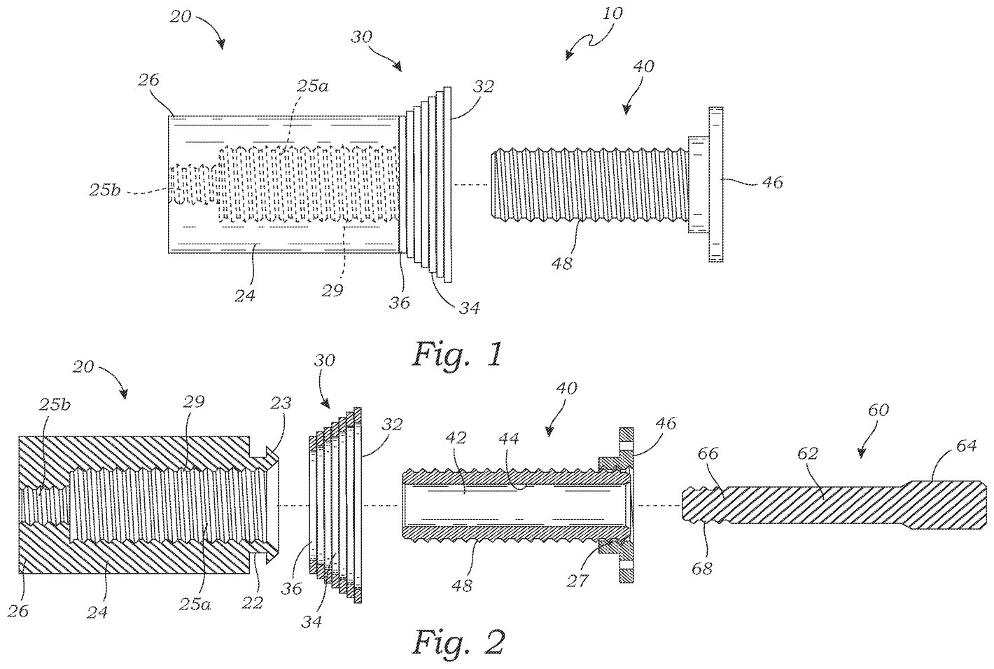

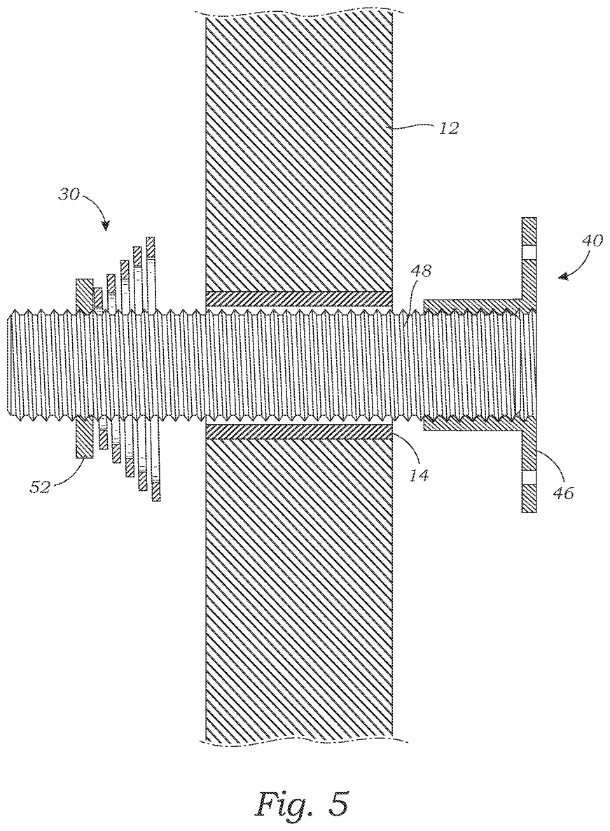

FIG. 1 is an exploded side elevational view of a fastener device 10 according to a first embodiment of the present invention, and FIG. 2 is a side sectional view thereof, illustrating an installation tool 60 which may be used in conjunction with the fastener. As shown in FIGS. 1-2, the fastener device 10 of this embodiment includes an inner stud 20, a spiral structure 30, and an outer fastener 40 (which may be in the form of a bolt, as shown) adapted for installation in the aperture of the wall, the wall 12 being shown in FIG. 5.

In this embodiment, the inner stud 20 is in the form of an elongate bolt that includes a head 22, and a shank 24 extending from the head 22 to a distal end 26. In this embodiment, the head 22 includes an upper rim 23 for engagement with the spiral structure 30, discussed in greater detail below. The shank 24 in this embodiment is thicker in diameter than the head 22, and includes an internally threaded bore 29 having a first section 25a extending from the head 22, and a second section 25b adjacent the distal end 26 that is smaller in diameter than the first section 25a (for receiving an installation tool 60, discussed in greater detail below).

As shown in FIGS. 1-2, the spiral structure 30 may be in the form of a spiral spring that includes a first end 32 having a larger diameter that is larger than the aperture in the wall, a middle section 34 which spirals inwardly to smaller diameters to a second end 36 which is attached to the upper rim 23 of the stud 20. The second end 36 has a diameter which is smaller than the diameter of the aperture, thereby allowing this end 36 to be inserted through the aperture. By twisting the spiral structure 30, all of the structure 36 may be fed through the aperture to get the structure entirely through the aperture. The spiral structure 30 may be constructed of a variety of materials, such as a spring steel, a suitable plastic, or other materials known in the art having suitable strength and flexibility suitable for this function.

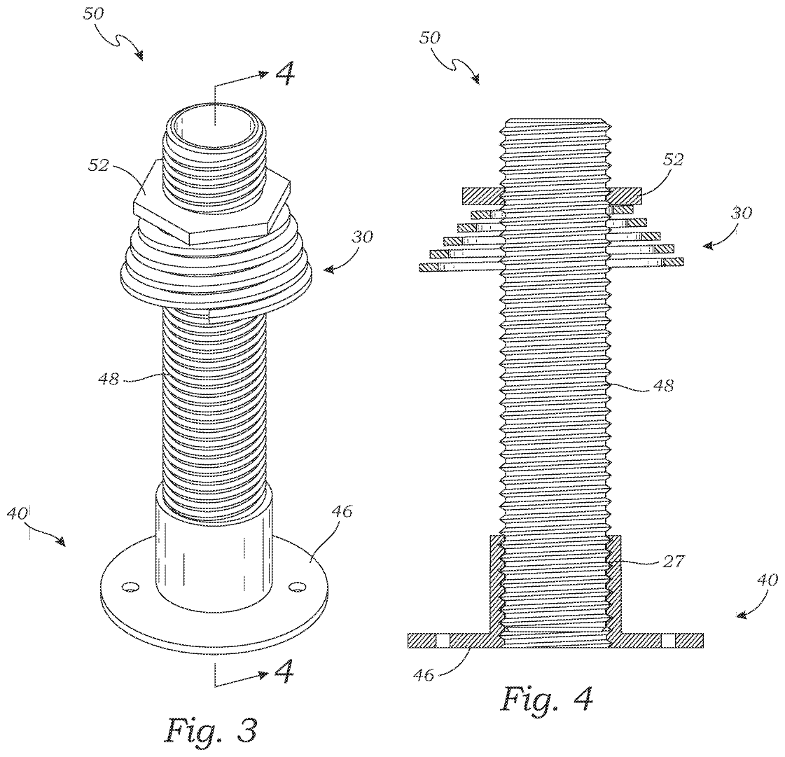

The outer fastener 40 has a first end 46 which may be in the form of a bolt head that is larger in diameter than the aperture of the wall, the first end 46 having an externally threaded shaft 48 extending therefrom, wherein the externally threaded shaft 48 is smaller in diameter than the aperture of the wall, and is sized to threadedly engage the first section 25a. The bolt head of the first end 46 may include two or more bores or other forms of structures which enable engagement of a wrench for turning the outer fastener 40. In some embodiments, the externally threaded shaft 48 is threadedly engaged with an internally threaded conduit 27 in 115 the first end 46 of the outer fastener 40, but in other embodiments, may be integrally formed (e.g., welded, molded, etc.) with the first end 46, as shown in the example of FIG. 5 and discussed below. In this embodiment, the externally threaded shaft 48 includes an inner conduit 42 that has an internal surface 44 that is smooth (not threaded) and extends from the first end 46 through the shaft 48. The externally threaded shaft 48 may have a diameter that is slightly smaller than the first section 25a of the internally threaded bore 29 of the inner stud 20, but larger than the second section 25b, so that the outer bolt 40 may engage the shank 24 while still providing access to the second section 25b. While one embodiment of the outer fastener 40 is shown, alternative structures may be implemented, as in the example of FIGS. 3-5.

As shown in FIG. 2, the fastener 10 may be installed in the wall using the installation tool 60. In this embodiment, the installation tool 60 includes an elongate body 62 having a first end 64 and a second end 66. The second end 66 may have an external surface 68 that may be threaded or otherwise shaped for removable engagement with the inner stud 20. The second end 66 of the tool body 62 has a diameter that is sized to threadedly or otherwise engage the second section 25b of the inner stud 20, so that the installation tool 60 may be threadedly engaged with the second section 25b to removably mount the inner stud 20 on the installation tool 60. The diameter of the elongate body 62 of the installation tool 60 is smaller than the inner conduit 42 diameter of the outer bolt 40, so that the installation tool 60 may move easily through the outer bolt 40 and the spiral structure 30.

In use, the fastener 10 may be installed into the aperture 14 of the wall 12 for hanging or supporting an attachment item (not shown), discussed below. At a first step of installation, the head 22 of the stud 20 is attached to the second end 36 of the spiral structure 30, and the outer fastener 40 is passed through the entire spiral structure 30 to threadedly engage the internally threaded bore 29 of the inner stud 20. A user may then insert the installation tool 60 through the outer bolt 40, the spiral structure 30, and into the internally threaded bore 29 of the stud 20, wherein the second end 66 threadedly engages with the second internally threaded section 25b. By twisting the installation tool 60, spiral structure 30 of the fastener 10 may then fed through the aperture of the wall, as noted above, until all of the structure 30 is on the inner side of the wall. The spiral structure 30 is then pulled against the wall via the tool 60, so that the structure 30 is flattened to form a flattened washer-like structure behind the wall. The outer bolt 40 is then inserted into the inner nut 20 and threadedly engaged. In a fully installed position, the larger diameter of the first end 46 of the outer fastener 40 prevents the fastener device 10 from being pushed fully through the wall aperture 14. Once the fastener 10 is tightened, it may be used to hold an item (not shown) securely in place between the externally threaded shaft 48 and the first end 46 of the outer fastener 40. In alternative embodiments, other forms of bolt or bolt-like device may be used. For example, the first end 46 may be in another form that is suitable for installation of different items, depending upon the requirements of the user.

At a final step of installation, once the spiral structure 40 has been twisted through the wall aperture 14, the first end 46 of the outer fastener 40 may be used to mount the item. In another embodiment (not illustrated), the user may mount the fastener device 10 without the attachment item, and after installation the attachment item may be fastened to the outer fastener 40, or other suitable structure. The attachment item may be any item or structure that one might with to mount to a wall, such as but not limited to picture frames or a form of frame-hanging mechanism, or other item that one might mount to the wall of a home or other building, a loop for attaching various types of lines, any structure that the user may want to mount on a wall of a vehicle, such as to an automobile, truck, RV, boat, etc. The number of items which can be mounted is without limit except for the imagination of the user.

FIG. 3 is a perspective view of a second embodiment of the fastener device 50, shown in an assembled configuration, and FIG. 4 is a sectional view thereof taken along line 4-4 in FIG. 3. As shown in the embodiment of FIGS. 3-4, the fastener device 50 of this embodiment includes an externally threaded shaft 48 having an outer fastener 40 threadedly mounted at one end, and an adjustable nut 52 threadedly mounted at the other end. The outer fastener 40 may include a bolt head having an outer flange 46 that is larger than the aperture through which the device 50 is to be installed. The spiral structure 30 is also threadedly mounted upon the shaft 48, and rotational movement of the spiral structure 30 is limited by the adjustable nut 52.

FIG. 5 is a sectional view of the fastener device 50 being installed in an aperture 14 of a wall 12. As shown in FIG. 5, the adjustable nut 52 may be moved, via turning (previous to installation), to different locations, thereby adjusting for the thickness of the wall (not shown) upon which the device 50 is being installed. Installation into the wall 12 is performed using freehand rotation of the outer fastener 40, as shown.

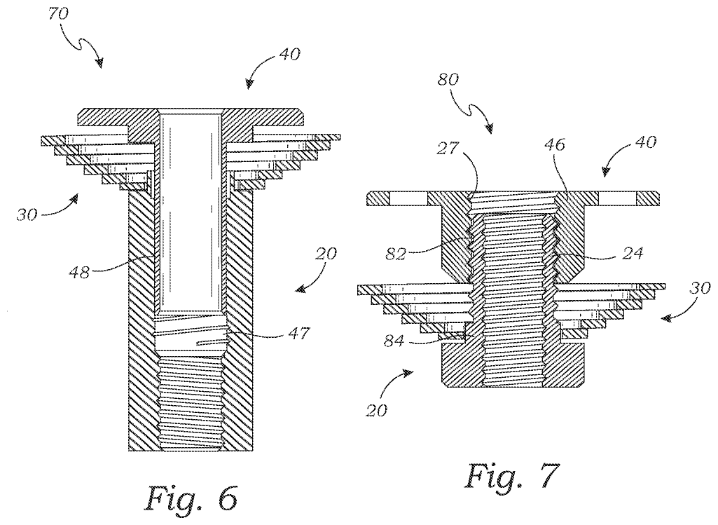

FIG. 6 is a sectional view of a third embodiment of the fastener device 70. Similar to the embodiment of FIGS. 1-2, the fastener device 70 includes the inner stud 20, the spiral structure 30, and the outer fastener 40. However, in this embodiment, the externally threaded shaft 48 of the outer fastener 40 is integrally formed (e.g., welded, molded, etc.) with the first end 46, and is further threaded only at a distal end 47 of the shaft 48, the rest of the shaft 48 being smooth.

FIG. 7 is a sectional view of a fourth embodiment 80 of the fastener device. As shown in FIG. 6, the fastener 80 includes the inner stud 20, the spiral structure 30, and the outer fastener 40. In this embodiment, the shank 24 of the inner stud 20 includes an external surface 82 that is at least partially threaded, such that the internally threaded conduit 27 in the first end 46 of the outer fastener 40 (as shown in FIGS. 1-2) may threadedly engage with the external surface 82 while in the installed position. The external surface 82 may further include a smooth, non-threaded section 84 adjacent the head 22, such that the spiral structure 30 may be flush and fit snugly on the bolt 20.

As used in this application, the words “a,” “an,” and “one” are defined to include one or more of the referenced item unless specifically stated otherwise. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

What is claimed is:

1. A fastener device adapted to be installed on a wall through an aperture of the wall, the aperture having an aperture diameter, the fastener device comprising:
an inner stud that is sized to fit through the aperture of the wall, the inner stud having a securing mechanism on an outer surface of the inner stud;
a spiral structure having an inner diameter that is sized to receive the inner stud, wherein the inner diameter engages with the securing mechanism of the inner stud such that the spiral structure is fixed in place and will not rotate relative to the inner stud, to facilitate insertion of the spiral structure through the aperture of the wall; and
an outer fastener that engages the inner stud to compress the spiral structure into a flattened washer-like structure behind the wall.

2. The fastener of claim 1, wherein the spiral structure engages with the inner stud at the inner diameter via an internally threaded inner surface.

3. The fastener of claim 1, wherein the spiral structure is in the form of a spiral that includes a first end having an inner diameter that is larger than the aperture in the wall, a middle section that spirals inwardly to smaller diameters to a second end having the inner diameter which is attached to the inner stud.

4. The fastener of claim 1, wherein the inner stud is in the form of a bolt that includes a head, and an externally threaded shank extending from the head to a distal end.

5. The fastener of claim 4, wherein the shank of the distal end of the inner stud further includes an internally threaded bore that extends at least partway up the shank toward the head.

6. The fastener of claim 4, wherein the securing mechanism includes an upper rim on the distal end of the inner stud for engagement with the spiral structure.

7. The fastener of claim 4, wherein the securing mechanism is the in the form of a smooth, non-threaded section adjacent the head of the inner stud, such that the spiral structure may be flush and fit snugly on the inner stud.

8. The fastener of claim 1, wherein the securing mechanism is the in the form of an adjustable nut that limits rotational movement of the spiral structure.

9. The fastener device of claim 1, further comprising an installation tool.
